(19) United States
(12) Patent Application Publication
(10) Pub. No.: US 2025/0072508 A1
(43) Pub. Date: Mar. 6, 2025

(54) AEROSOL PROVISION DEVICE

(71) Applicant: Nicoventures Trading Limited, London (GB)

(72) Inventors: Conor MCGRATH, London (GB); Matthew HOLDEN, London (GB); Jorge GOMEZ, London (GB)

(21) Appl. No.: 18/722,140

(22) PCT Filed: Dec. 19, 2022
(86) PCT No.: PCT/EP2022/086667

§ 371 Date: Jun. 20, 2024

(30) Foreign Application Priority Data
Dec. 22, 2021 (GB) 2118812.3

(51) Int. Cl. A24F 40/465; A24F 40/20; H05B 6/10; H05B 6/36

(52) U.S. Cl. CPC A24F 40/465; A24F 40/20; H05B 6/105; H05B 6/36; H05B 2206/022

(57) ABSTRACT

An aerosol provision device generates an aerosol from aerosol-generating material. The device has a receptacle defining a heating zone for receiving at least a portion of an article containing aerosol-generating material. The receptacle includes a peripheral wall and a protrusion protruding into the heating zone from the peripheral wall. The peripheral wall and the protrusion are formed from different materials.

### RELATED APPLICATIONS

The present application is a National Phase entry of PCT Application No. PCT/EP2022/086667 filed Dec. 19, 2022, which claims priority to GB Application No. 2118812.3 filed Dec. 22, 2021, each of which is hereby incorporated by reference in their entirety.

### TECHNICAL FIELD

The present invention relates to an aerosol provision device. The present invention also relates to an aerosol provision system comprising an aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device for generating an aerosol from aerosol-generating material comprising: a receptacle defining a heating zone for receiving at least a portion of an article containing aerosol-generating material; the receptacle comprising a peripheral wall, a protrusion protruding from the peripheral wall into the heating zone, wherein the peripheral wall and the protrusion are formed from different materials.

The peripheral wall may comprise a heating element. The peripheral wall may comprises a material heatable by penetration with a magnetic field.

The protrusion may be free from a material heatable by penetration with a magnetic field. The protrusion may be formed of polyether ether ketone (PEEK).

The peripheral wall may be a tubular member.

The protrusion may be a rib.

The protrusion may extend axially.

The protrusion may be mounted on an inner surface of the peripheral wall.

The protrusion may be adhered to the inner surface of the peripheral wall.

The receptacle may comprise an aperture in the peripheral wall. The protrusion may protrude through the aperture in the peripheral wall into the heating zone.

The aperture may be elongate. The aperture may be a slot. The aperture may extend longitudinally.

The protrusion may comprise a base and a protruding portion.

The protrusion may be correspondingly shaped to the aperture.

The aerosol provision device may comprise an outer sealing member. The peripheral wall may be at least partially received by the outer sealing member. The peripheral wall may be fully received by the outer sealing member. The outer sealing member may be tubular.

The aerosol provision device may comprise a seal between the peripheral wall and the outer sealing member.

The aerosol provision device may comprise a cavity defined between the peripheral wall and the outer sealing member. The seal may be arranged to seal the cavity.

The protrusion may protrude from the outer sealing member. The protrusion and the outer sealing member may be integrally formed. The protrusion and the outer tubular member may be a one-piece component.

The aerosol provision device may comprise a plurality of apertures provided in the peripheral wall. The aerosol provision device may comprise a plurality of protrusions. Each protrusion may protrude through a respective aperture in the peripheral wall.

The aerosol provision device may comprise an inductor coil. The outer sealing member may act as an inductor coil support.

The protrusion may be arranged to space an outer surface of the article from the peripheral wall. The protrusion may be arranged to space the outer surface of the article from an inner surface of the receptacle. The protrusion may be arranged to space the outer surface of the article from the peripheral wall of the receptacle.

In accordance with some embodiments described herein, there is provided an aerosol provision device for generating an aerosol from aerosol-generating material comprising: a receptacle defining a heating zone for receiving at least a portion of an article containing aerosol-generating material; the receptacle comprising a peripheral wall and an aperture in the peripheral wall; and a protrusion protruding through the aperture in the peripheral wall into the heating zone.

The peripheral wall may comprise a heating element. The peripheral wall may comprises a material heatable by penetration with a magnetic field.

The protrusion may be free from a material heatable by penetration with a magnetic field.

The protrusion may be formed of polyether ether ketone.

The peripheral wall may be a tubular member.

The protrusion may be a rib.

The protrusion may extend axially.

The aperture may be elongate. The aperture may be a slot. The aperture may extend longitudinally.

The protrusion may comprise a base and a protruding portion.

The protrusion may be correspondingly shaped to the aperture.

The aerosol provision device may comprise an outer sealing member. The peripheral wall may be at least partially received by the outer sealing member. The peripheral wall may be fully received by the outer sealing member. The outer sealing member may be tubular.

The aerosol provision device may comprise a seal between the peripheral wall and the outer sealing member.

The aerosol provision device may comprise a cavity defined between the peripheral wall and the outer sealing member. The seal may be arranged to seal the cavity.

The protrusion may protrude from the outer sealing member. The protrusion and the outer sealing member may be integrally formed. The protrusion and the outer tubular member may be a one-piece component.

The aerosol provision device may comprise a plurality of apertures provided in the peripheral wall. The aerosol provision device may comprise a plurality of protrusions. Each protrusion may protrude through a respective aperture in the peripheral wall.

The aerosol provision device may comprise an inductor coil.

The outer sealing member may act as an inductor coil support.

The protrusion may be arranged to space an outer surface of the article from the inner surface of the peripheral wall. The protrusion may be arranged to space the outer surface of the article from the inner surface of the receptacle. The protrusion may be arranged to space the outer surface of the article from the peripheral wall of the receptacle.

In accordance with some embodiments described herein, there is provided an aerosol provision system comprising one of the aerosol provision devices described above and an article containing aerosol generating material, in which the article is at least partially receivable in the heating zone of the aerosol provision device.

### BRIEF DESCRIPTION OF THE DRAWINGS

Embodiments of the invention will now be described, by way of example only, with reference to accompanying drawings, in which:

FIG. 1 shows a schematic front view of an aerosol provision device;

FIG. 2 shows a schematic cross-sectional side view of the aerosol provision device of FIG. 1;

FIG. 3 shows a schematic cross-sectional side view of another configuration of the aerosol provision device of FIG. 1;

FIG. 4 shows a part cut-away perspective view of part of an aerosol generator for the aerosol provision device of FIG. 1;

FIG. 5 shows a schematic cross-sectional plan view of the part of the aerosol generator of FIG. 3;

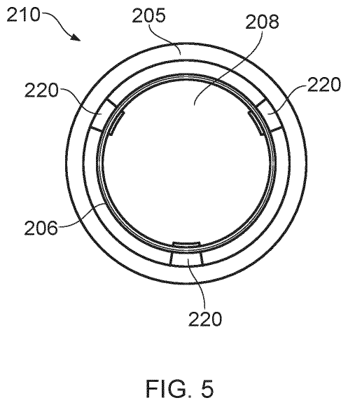

FIG. 6 shows a schematic cross-sectional side view of another configuration of the aerosol provision device of FIG. 1; and

FIG. 7 shows a schematic cross-sectional side view of another configuration of the aerosol provision device of FIG. 1.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

As used herein, one-piece component refers to a component of the device which is formed as a single component during manufacture and is not separable into two or more components following. Integrally formed relates to two or more features that are formed into a one piece component during a manufacturing stage of the component.

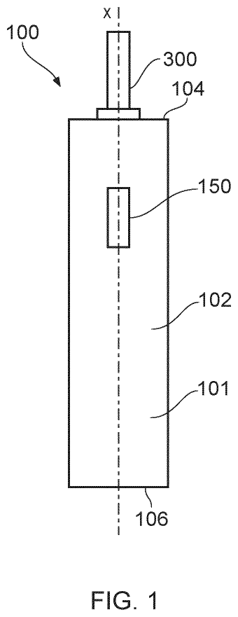

FIG. 1 shows an aerosol provision device 100 for generating aerosol from an aerosol generating material. In broad outline, the device 100 may be used to heat a replaceable article 300 comprising the aerosol generating material, to generate an aerosol or other inhalable material which is inhaled by a user of the device 100. The article 300 and the device 100 together form an aerosol provision system.

The device 100 includes a body 101. The body 101 comprises a housing 102. The article 300 is partially inserted in the body 101 through an opening 103. The article 300 protrudes from the body 101. The user draws on the protruding end of the article 300 to draw aerosol generated in the device 100.

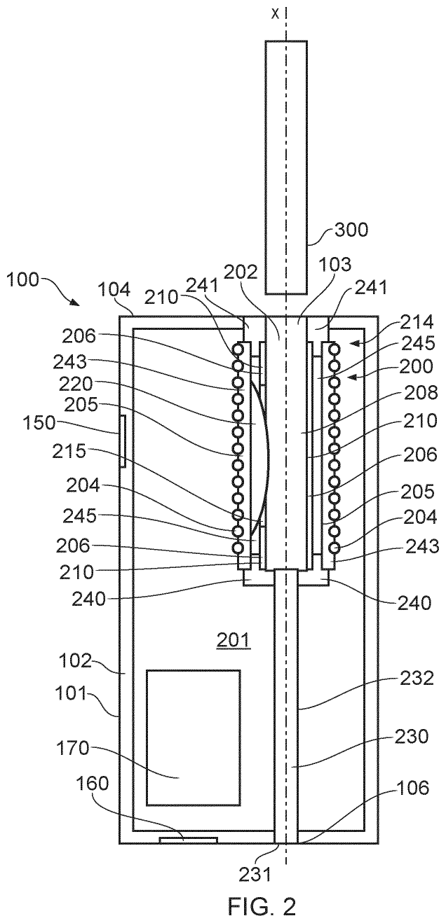

Referring now to FIG. 2, the housing 102 houses components of the device 100, including an aerosol generator 200. The aerosol generator 200 comprises various components for generating an aerosol from the received article. In one example, the article 300 is heated by a heater assembly to generate aerosol. The housing 102 has the opening 103 in one end, through which the article may be inserted for heating. In use, the article 300 may be fully or partially inserted into the device where it may be heated by one or more components.

The housing 102 of the device 100 encapsulates the aerosol generator 200. That is the housing 102 surrounds the aerosol generator 200 such that access to the aerosol generator 200 is prevented when the housing is present, with the exception of the opening 103 for inserting the article 300. The housing 102 defines a component cavity 201 in which the aerosol generator is received. The housing 102 acts as a barrier to the component cavity 201 so as to contain the aerosol generator 200 and provide protection from the environment. The housing 102 protects the user from the components of the device 100, for example preventing contact with electrical components and/or providing thermal insulation from the heated components. The housing 102 may act as a fluid barrier.

The end of the device 100 closest to the opening 103 may be known as the proximal end (or mouth end) 104 of the device 100 because, in use, it is closest to the mouth of the user. In use, a user inserts an article 300 into the opening 103, operates the aerosol generator 200 to begin heating the aerosol generating material and draws on the aerosol generated in the device. This causes the aerosol to flow through the device 100 along a flow path towards the proximal end of the device 100.

The other end of the device furthest away from the opening 103 may be known as the distal end 106 of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the longitudinal axis.

The aerosol generator 200 defines a longitudinal axis X which extends in a direction from the proximal end 104 to the distal end 106.

The device 100 also includes a user-operable control element 150, such as a button or switch, which operates the device 100 when pressed. For example, a user may turn on the device 100 by operating the switch. The switch may form part of the housing 102.

The device 100 also comprises an electrical component, such as a connector/port 160, which can receive a cable to charge a battery of the device 100. For example, the connector 160 may be a charging port, such as a USB charging port. In some examples the connector 160 may be used additionally or alternatively to transfer data between the device 100 and another device, such as a computing device.

The device 100 comprises a power source 170 (refer to FIG. 2), for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The aerosol generator 200 defines an article receiving chamber 202 extending from the opening 103. A receptacle 210 forms the article receiving chamber 202. The receptacle 210 defines a heating zone 208. The article receiving chamber 202 is isolated from the component cavity 201. The heating zone 208 is within the article receiving chamber 202.

The receptacle 210 comprises a tubular member. Embodiments of the receptacle 210 will be described in further detail below.

An air flow passage 230 extends through the body 101. The air flow passage 230 extends from an air inlet 231 to the opening 103. The receptacle 210 forms at least part of the air flow passage 230. A flow path member 232 extends from the receptacle 210. The flow path member 232 is at the distal end. The flow path member 232 extends between the receptacle 210 and the air inlet 231. The flow path member 232 is tubular. The flow path member 232 defines a bore. The flow path member 232 extends in an axial direction. The flow path member 232 and the receptacle 210 intersect at a juncture 233.

A first end support 240 supports the receptacle 210. The first end support 240 supports the receptacle 210 at a first, distal, end. A second end support 241 supports the receptacle 210. The second end support 241 supports the receptacle 210 at a second, proximal, end. The first and second end supports 240, 241 act as receptacle supports. The first end support 240 defines an end of the receptacle 210. The first end support 240 may define a base of the article receiving chamber 202. The first end support 240 forms an end wall 242. In embodiments this is not the case, and the receptacle 210 comprises an end wall. The flow path member 232 extends from the first end support 240. In embodiments, the first end support 240 defines at least part of the flow path member 232. In embodiments, the flow path member 232 is omitted.

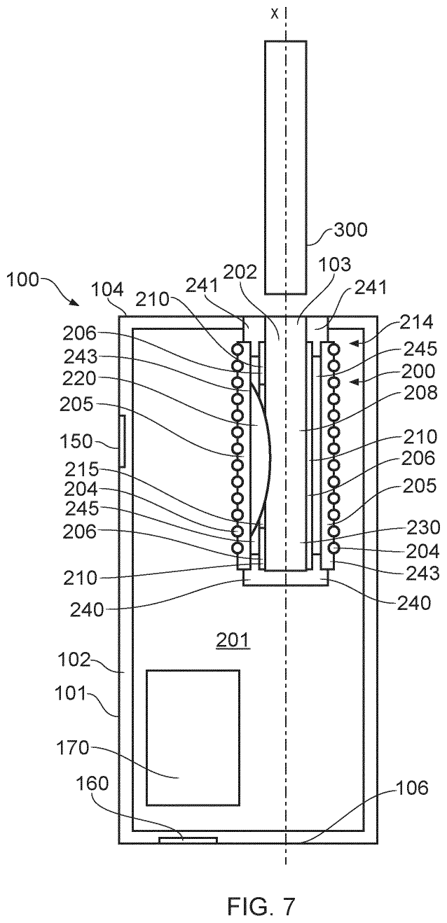

In embodiments, the air flow through the flow path through the device differs. As described above, the flow path is defined as a through bore through the device along a flow path member to the receptacle such that air is drawn through the article. In the configuration shown in FIG. 7, the article receiving chamber 202 has a closed end. In this embodiment, the first end support 240 defines a closed end of the receptacle. The first end support 240 acts as a base of the receptacle. The air path 230 is defined from an open proximal end of the receptacle 210 at the aperture 104, between the receptacle 210 and the article 300 to the closed end and then into the article 300 at the closed end to flow back towards the proximal end through the article 300. In other respects, the configuration shown in FIG. 7 is similar to that of FIG. 1.

The aerosol generator 200 comprises an induction-type heater, including a magnetic field generator 214. The magnetic field generator 214 comprises an inductor coil 204. The aerosol generator 200 comprises a heating element 206. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 200 is an inductive heating assembly and comprises various components to heat the aerosol generating material of the article 300 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil 204 is in communication with the power source 170, which energises the coil to generate a varying magnetic flux. The magnetic flux generates a current in the susceptor, which in turn causes the susceptor 206 to heat. The susceptor is in heat communication with the article 300, and heats the article 300 to generate an aerosol.

The inductor coil 204 is a helical coil. In embodiments, the number of inductor coils differs. The coil 204 extends around a coil support 205. The coil support 205 acts to hold the coil in position. In this embodiment, the coil support 205 is provided by an outer sealing member 243. In other embodiments, these may be separate components. The coil support 205 extends in a longitudinal direction of the longitudinal axis X. The coil 204 comprises a number of turns. The turns extend around the coil support 205. The coil support 205 is tubular.

The receptacle 210 comprises the heating element 206. The heating element 206 forms a peripheral wall 216 of the receptacle 210. In other embodiments, the heating element and the receptacle are separate components. In embodiments, the receptacle 210 forms the peripheral wall 216.

The heating element 206 is part of a heating assembly. The heating element 206 of this example is hollow and therefore defines at least part of the receptacle 210 within which aerosol generating material is received. For example, the article 300 can be inserted into the heating element 206. The heating element 206 is tubular, with a circular cross section. The heating element 206 has a generally constant diameter along its axial length.

The heating element 206 is encircled by a coil support 205. The heating element 206 is encircled by the inductor coil 204. In other embodiments, only part of the heating element 206 is encircled by the inductor coil 204.

The heating element 206 is formed from an electrically conducting material suitable for heating by electromagnetic induction. The heating element 206 in the present example is formed from a carbon steel. It will be understood that other suitable materials may be used, for example a ferromagnetic material such as iron, nickel or cobalt.

In other embodiments, the feature acting as the heating element 206 may not be limited to being inductively heated. The feature, acting as a heating element, may therefore be heatable by electrical resistance. The aerosol generator 200 may therefore comprise electrical contacts for electrical connection with the apparatus for electrically activating the heating element by passing a flow of electrical energy through the heating element.

In use, alternating current is supplied to the coil 204 by the power source 170. The alternating current in the inductor coil 204 generates a varying magnetic flux adjacent to the heating element 206. The magnetic flux generates a current in the heating element 206, which in turn causes the heating element 206 to heat.

The heating element 206 extends between the first and second end supports 240, 241. An outer sealing member 243 extends between the first end support 241 and the second end support 242.

The outer sealing member 243 together with the first and second end supports 240, 241 encloses the heating element 206. This helps to assist with thermally isolating the heating element 206 from other components of the device 100. The outer sealing member 243 is a hollow, tubular member. The outer sealing member 243 acts as an outer tubular member, with the receptacle 210 forming an inner tubular member. The outer sealing member acts to help fluidly isolate the receptacle from other components of the device 100.

The outer sealing member 243 is fixedly mounted to the first and second end supports 240, 241. The first end support 240 closes the distal end of the outer sealing member 243. The second end support 241 closes the proximal end of the outer sealing member 243. The outer sealing member 243 partially overlaps the first and second end supports 240, 241.

The outer sealing member 243 forms a fluid seal with the first and second end supports 240, 241. In embodiments a mechanical fabricated joint, for example a weld, is formed between the outer sealing member 243 and each of the first and second end supports 240, 241. The fluid seal at the junction of the parts is formed by a weld process, however it will be understood that other methods may be used such as brazing and adhering. In embodiments, the outer sealing member 243, and first and second end supports 240, 241 are formed from the same material.

In embodiments, the outer sealing member 243 is formed from a non-metallic material to assist with limiting interference with magnetic induction. In this particular example, the outer sealing member 243 is constructed from polyether ether ketone (PEEK). The first and second end supports 240, 241 are constructed from PEEK. Other suitable materials are possible. Parts formed from such materials help ensure that the outer sealing member 243 remains rigid/solid when the susceptor is heated.

The heating element 206, the outer sealing member 243, and the first and second end supports 240, 241 are coaxial around the central longitudinal axis of receptacle. The heating element 206, the outer sealing member 243, and the first and second end supports 240, 241 define a closed chamber 245. The closed chamber 245 encircles at least part of the heating element 206. The closed chamber 245 is defined by a gap between the heating element 206 and the outer sealing member 243.

In embodiments the outer sealing member 243 has a different arrangement. In embodiments, the outer sealing member 243 is in contact with the receptacle 210. In embodiments, the outer sealing member 243 is a layer around the outer surface of the receptacle 210. In such an arrangement, the outer sealing member 243 may be a wrap. The outer sealing member 243 may be bonded to the receptacle 210.

In this embodiment, the outer sealing member 243 forms the coil support 205. In other embodiments, the coil support 205 surrounds the outer sealing member 243. The coil support encircles the outer sealing member 243.

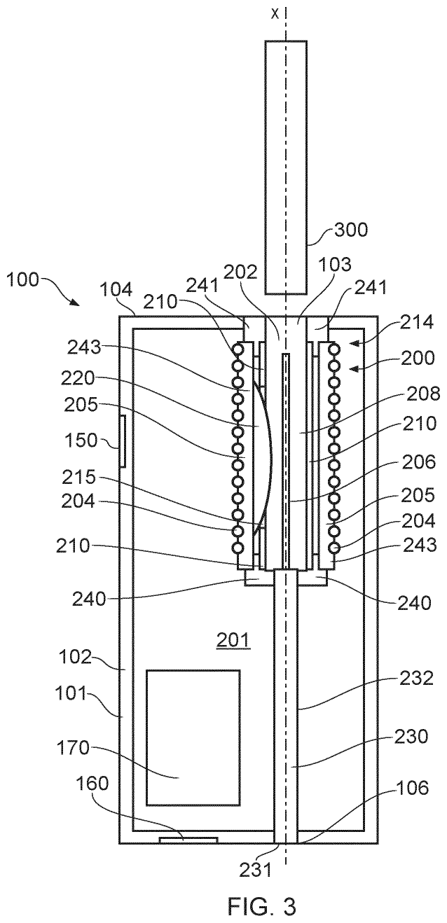

FIG. 3 shows another configuration of the aerosol generating device 100. This embodiment is substantially the same as the embodiments described above with reference to FIG. 2, except that the heating element 206 is a separate component to the receptacle 210. Like reference numerals will be used to refer to like features. The heating element 206 is a member protruding in the heating zone. The heating element extends into the heating zone 208. The heating element extends in the direction of the longitudinal axis of the aerosol generating device. The heating element 206 protrudes into the heating zone 208 from the distal end. The heating element upstands from the receptacle 210. In such an arrangement, the heating element 206 does not form the receptacle 210. The receptacle is formed in embodiments from a material free from material heatable by penetration with a varying magnetic field.

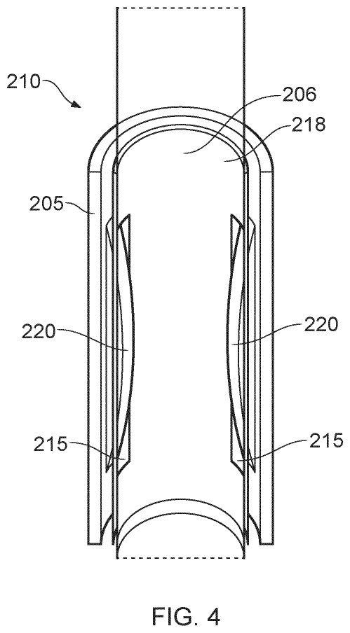

FIG. 4 shows a part cut-away perspective view of the receptacle 210 and outer sealing member 243. In an embodiment in which the receptacle 210 forms the heating element, for example as part of an inductive heating system, then the receptacle 210 is formed of a material susceptible to heating by penetration with a varying magnetic field. In embodiments, the receptacle 210 is free from material heatable by penetration with a varying magnetic field, for example when the heating element 206 protrudes in the heating zone 208.

The receptacle 210 defines the heating zone 208. A portion of the article 300 is receivable in the heating zone 208. The receptacle 210 comprises a peripheral wall 216. The peripheral wall 216 defines the heating zone 208.

The receptacle 210 is tubular. The peripheral wall 216 is cylindrical. In other embodiments, shapes of different cross section may be used.

The receptacle 210 includes an opening 218 (see FIG. 4). The opening is sized to receive the article 300. The opening 218 is situated at a proximal end of the receptacle 210. The opening 218 communicates with the opening 103. The opposing end comprises a base. The base may be formed by a base wall (not shown in FIG. 4). The base may be provided by the first end support 240.

The receptacle 210 includes a plurality of apertures 215. The apertures 215 are provided in the peripheral wall 216. The apertures 215 are elongate slots. The apertures 215 extend in an axial direction of the device 100. In this embodiment, three apertures 215 are provided. In embodiments, a different number of apertures may be provided. For example, as few as one aperture or as many as twenty or more apertures may be provided. The apertures 215 are evenly distributed around the circumference of the receptacle. The spacing of the apertures, sizing, relative sizings and positioning may differ. In embodiments, the apertures are open to an edge of the peripheral wall 216. That is, the apertures may be notches.

In this embodiment, the peripheral wall 216 is formed from a material heatable by penetration with a varying magnetic field. In embodiments, the peripheral wall 216 may be formed from another material, such as polyether ether ketone.

The apertures 215 may be formed by a CNC router, a stamping process, chemical etching or laser cutting, or the receptacle may be die cast or 3D printed to include the apertures. The apertures 215 may be formed in a sheet of material which is subsequently formed into a tube to provide the receptacle. In other embodiments, the apertures 215 are formed in a tubular material and no subsequent forming into a tube is necessary. In embodiments, the sheet is joined to form a cylinder. In embodiments, the sheet is not joined and the tube is not circumferentially closed.

The aerosol provision device 100 includes a plurality of protrusions 220 corresponding to the plurality of apertures 215. In this embodiment, one protrusion 220 is provided for each aperture 215. In other embodiments, multiple protrusions may be provided for each aperture 215. The protrusions 220 protrude into the heating zone 208 from the peripheral wall 216. The protrusions 220 extend through the apertures 215. In this embodiment, the receptacle includes three protrusions 220. The number of protrusions may differ, for example three, four, five or six. In embodiments there may be a single protrusion. The protrusions 220 are evenly spaced circumferentially around the peripheral wall 216. The spacing of the protrusions 220, sizing, relative sizings and positioning may differ. A single protrusion will be described below in detail.

The protrusion 220 is elongate. The protrusion 220 extends in an axial direction. The protrusion 220 extends substantially parallel to the other protrusions. The protrusion 220 forms a rib. The protrusion 220 extends sufficiently into the heating zone 208 to abut an outer surface of the article 300. In embodiments the protrusion 220 protrudes to a radial extent sufficient to compress a corresponding article received in the heating zone 300. The protrusion 220 has an arcuate outer surface. That is, the surface of the protrusion 220 which faces towards the heating zone 208 is arcuate. The protrusion 220 has a convex outer surface.

The protrusion 220 is joined to the outer sealing member 243. In this embodiment, the protrusion 220 and the outer sealing member 243 form a one piece component. In embodiments, the protrusion 220 and the outer sealing member 243 are joined by an adhesive, welding, or fixing means such as screws.

The protrusion 220 may be resilient. The protrusion 220 may be movable and biased in an inwards radial direction. This allows the protrusion to grip the article 300 so that the article 300 does not move in or fall out of the heating zone, without deforming the surface of the article 300 which may damage it.

In use, the article 300 is inserted via the opening 103 into the receptacle 210. The article 300 is securely held by the protrusion 220. In this embodiment, the outer surface of the article is compressed by the protrusion 220. In embodiments, the protrusion 220 is outwardly deflected by the article 300. The protrusion 220 is then resilient or biased inwardly to provide a gripping force on the article 300. In embodiments, the article 300 is compressed by the protrusion 220 and the protrusion is deflected outwardly by the article 300.

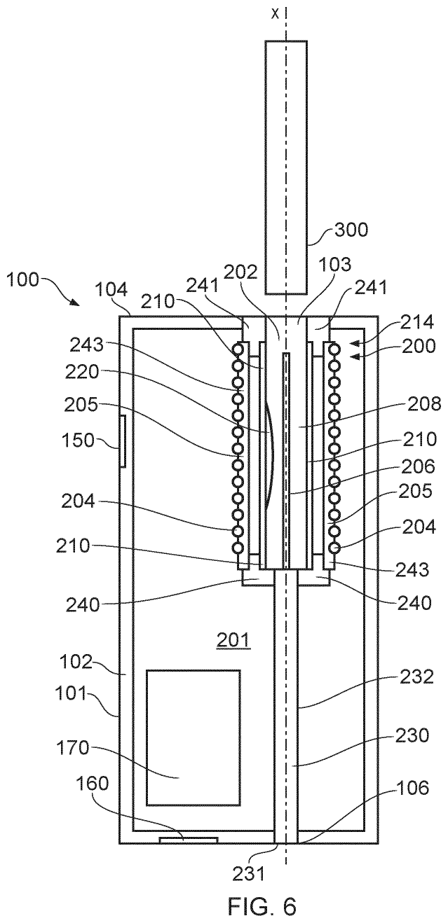

By providing protrusions separate to the receptacle 210, the protrusions may be formed of a different material. For example, the protrusions 220 may be formed of polyether ether ketone. The protrusions 220 may be formed of a material which is less likely to damage the article 300. The protrusions may be provided as a one piece component with the outer sealing member 243. FIG. 6 shows another configuration of the aerosol generating device 100 of FIG. 1. The protrusions 220 are mounted on the surface of the receptacle 210. The receptacle 210 is free from apertures. In such an embodiment, the heating element 206 may be as described in relation to FIG. 3. In embodiments, the heating element 206 may be as described in relation to FIG. 2 and the protrusions 220 are mounted on the surface of the heating element 206.

The protrusions 220 are formed from a different material to the receptacle 220. In embodiments, the protrusions are free from a material heatable by penetration with a magnetic field. The protrusions 220 are fixed to the receptacle 210. In embodiments, the protrusions 220 and the receptacle 210 are bonded, for example by an adhesive. In embodiments, the protrusions 220 and the receptacle 210 are joined by a mechanical fixing, such as screws. This provides for simpler manufacture of the receptacle 210 and or heating element 206, while allowing the protrusions 220 to be formed of a different material to the receptacle 210.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating an aerosol from aerosol-generating material comprising:
a receptacle defining a heating zone for receiving at least a portion of an article containing aerosol-generating material; the receptacle comprising a peripheral wall;
a protrusion protruding from the peripheral wall into the heating zone;
wherein the peripheral wall and the protrusion are formed from different materials.

2. The aerosol provision device of claim 1, wherein the peripheral wall comprises a heating element.

3. The aerosol provision device of claim 1, wherein the peripheral wall comprises a material heatable by penetration with a magnetic field.

4. The aerosol provision device of claim 1, wherein the protrusion is free from a material heatable by penetration with a magnetic field.

5. The aerosol provision device of claim 1, wherein the peripheral wall is a tubular member.

6. The aerosol provision device of claim 1, wherein the protrusion is an axially extending rib.

7. The aerosol provision device of claim 1, wherein the protrusion is mounted on an inner surface of the peripheral wall.

8. The aerosol provision device of claim 1, wherein the receptacle comprises an aperture in the peripheral wall; and wherein the protrusion protrudes through the aperture in the peripheral wall into the heating zone.

9. The aerosol provision device of claim 8, wherein the protrusion is correspondingly shaped to the aperture.

10. The aerosol provision device of claim 1, comprising an outer sealing member, wherein the peripheral wall is at least partially received by the outer sealing member.

11. The aerosol provision device of claim 10, comprising a seal between the peripheral wall and the outer sealing member.

12. The aerosol provision device of claim 10, comprising a cavity defined between the peripheral wall and the outer sealing member.

13. The aerosol provision device of claim 10, wherein the protrusion protrudes from the outer sealing member.

14. The aerosol provision device of claim 10, wherein the protrusion and the outer sealing member are a one-piece component.

15. The aerosol provision device of claim 10, comprising an inductor coil, wherein the outer sealing member acts as an inductor coil support.

16. The aerosol provision device of claim 1, comprising a plurality of protrusions.

17. The aerosol provision device of claim 1, wherein the protrusion is arranged to space an outer surface of the article from the peripheral wall.

18. The aerosol provision device of claim 1, wherein the protrusion comprises a rib.

19. An aerosol provision device for generating an aerosol from aerosol-generating material comprising:
a receptacle defining a heating zone for receiving at least a portion of an article containing aerosol-generating material; the receptacle comprising a peripheral wall and an aperture in the peripheral wall; and
a protrusion protruding through the aperture in the peripheral wall into the heating zone.

20. An aerosol provision system comprising the aerosol provision device of claim 1 and an article containing aerosol generating material, in which the article is at least partially receivable in the heating zone of the aerosol provision device.

21. An aerosol provision system comprising the aerosol provision device of claim 19 and an article containing aerosol generating material, in which the article is at least partially receivable in the heating zone of the aerosol provision device.
